(19) United States
(12) Patent Application Publication
(10) Pub. No.: US 2026/0266352 A1
(43) Pub. Date: Sep. 10, 2026

(54) SHOCK ABSORBER

(71) Applicant: KYB Motorcycle Suspension Co.,Ltd, Gifu (JP)

(72) Inventor: Wataru ISHIHARA, Gifu (JP)

(73) Assignee: KYB Motorcycle Suspension Co.,Ltd, Gifu (JP)

(21) Appl. No.: 19/555,537

(22) Filed: Mar. 3, 2026

(30) Foreign Application Priority Data
Mar. 10, 2025 (JP) 2025-037592

(51) Int. Cl. F16F 13/00; F16F 9/36; F16F 9/38

(52) U.S. Cl. CPC F16F 13/007; F16F 9/36; F16F 9/362; F16F 9/38; F16F 2230/0005; F16F 2230/0023; F16F 2230/007; F16F 2230/02; F16F 2230/30; F16F 2232/08; F16F 2234/02

(57) ABSTRACT

A shock absorber according to the present invention includes: a shock absorber main body including an outer tube and a rod to generate a damping force during extension or contraction; an outer tube-side spring seat attached to an outer periphery of the outer tube; a rod-side spring seat attached to the rod; a coil spring interposed between the outer tube-side spring seat and the rod-side spring seat; a stopper provided on the outer tube so as not to be movable in an axial direction; a cap body including a flange on an outer periphery thereof and fixed to a rod-side end of the outer tube; and a tubular protector sandwiched between the stopper and the flange and fixed to the outer periphery of the outer tube while covering a part of the outer tube to prevent interference between the coil spring and the outer tube.

### BACKGROUND

### Technical Field

The present invention relates to a shock absorber.

Related Art

A shock absorber used in a saddle-type vehicle such as a motorcycle, a snowmobile, or an all-terrain vehicle includes, for example, a shock absorber main body including a cylinder, a rod movably inserted into the cylinder, and a piston connected to the rod and slidably inserted into the cylinder, and a coil spring interposed between the rod and the cylinder to elastically support a vehicle body of the saddle-type vehicle.

In such a shock absorber integrally provided with a coil spring, it may be required to reduce the outer diameter of the coil spring from the viewpoint of mountability on the saddle-type vehicle. On the other hand, when the shock absorber is required to exhibit a high damping force, it is necessary to increase the diameter of the cylinder in order to increase the cross-sectional area of the piston.

When the outer diameter of the coil spring is reduced from the viewpoint of mountability, the aspect ratio of the coil spring increases, making the coil spring more likely to buckle during contraction of the shock absorber. Therefore, when the diameter of the cylinder is increased to meet the demand for exhibiting a high damping force, the coil spring may buckle and interfere with the cylinder during contraction of the shock absorber, which may accelerate the deterioration of the cylinder and the coil spring.

Therefore, in a conventional shock absorber, for example, as disclosed in JP 2016-142299 A, a tubular protector is placed on an outer periphery in the vicinity of a rod-side end of a cylinder facing a center portion in an axial direction of a coil spring, so that the protector prevents interference between the coil spring and the cylinder, even if the coil spring buckles, to protect the coil spring and the cylinder.

### SUMMARY

In a conventional shock absorber, when fixing a protector to a cylinder, two annular grooves extending along a circumferential direction are provided at an end portion on a rod side of the cylinder, with a C-shaped stopper ring assembled in one of the annular grooves on a side of the cylinder opposite to the rod side, and a stopper ring placed in the other annular groove on the rod side after the protector is fitted onto an outer periphery of the cylinder, so that the protector is sandwiched between the two stopper rings.

As described above, in the conventional shock absorber, the two stopper rings are placed on the cylinder, and the protector is fixed to the cylinder by sandwiching the protector between the two stopper rings. However, the task of placing the stopper rings on the cylinder is troublesome, making workability in the assembly process poor. In addition, in the conventional shock absorber, the stopper rings are fitted in the annular grooves in an exposed state. Therefore, when a load is applied to the stopper ring in the axial direction, there is a possibility that the stopper rings may expand and come out of the annular grooves, and accordingly, there is a possibility that the protector may fall off from the cylinder.

Therefore, an object of the present invention is to provide a shock absorber capable of improving assembly workability and suppressing a protector from falling off.

In order to solve the aforementioned problems, a shock absorber according to the present invention includes: a shock absorber main body including an outer tube and a rod inserted into the outer tube so as to be movable in an axial direction to generate a damping force during extension or contraction; an outer tube-side spring seat attached to an outer periphery of the outer tube; a rod-side spring seat attached to the rod; a coil spring interposed between the outer tube-side spring seat and the rod-side spring seat with the outer tube and the rod inserted inside an inner periphery thereof; a stopper provided on the outer tube so as not to be movable in the axial direction; a cap body having an annular shape, allowing insertion of the rod, including a flange on an outer periphery thereof, and fixed to a rod-side end of the outer tube; and a tubular protector sandwiched between the stopper and the flange and fixed to the outer periphery of the outer tube while covering a part of the outer tube to prevent interference between the coil spring and the outer tube.

According to the shock absorber configured as described above, when fixing the protector to the outer tube, by providing the stopper on the outer periphery of the outer tube, and attaching the cap body to the outer tube, the protector is sandwiched between the stopper and the flange, whereby the protector can be firmly fixed to the outer tube, and the protector can be easily assembled to the outer tube.

### BRIEF DESCRIPTION OF DRAWINGS

FIG. 1 is a partially cutaway side view of a shock absorber according to one embodiment;

FIG. 2 is a plan view of a protector according to one modification;

FIG. 3 is a partial cross-sectional view of a shock absorber according to a first modification of the embodiment;

FIG. 4 is a partial cross-sectional view of a shock absorber according to a second modification of the embodiment; and

FIG. 5 is a partial cross-sectional view of a shock absorber according to a third modification of the embodiment.

### DETAILED DESCRIPTION

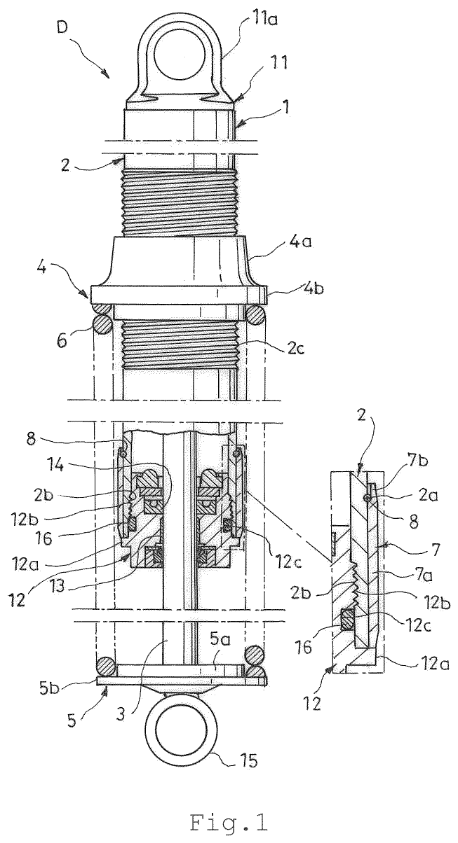

The present invention will be described based on an embodiment illustrated in the drawings. As illustrated in FIG. 1, a shock absorber D according to one embodiment includes a shock absorber main body 1 including an outer tube 2 and a rod 3 inserted into the outer tube 2 so as to be movable in an axial direction to generate a damping force during extension or contraction, an outer tube-side spring seat 4 attached to an outer periphery of the outer tube 2, a rod-side spring seat 5 attached to the rod 3, a coil spring 6 interposed between the outer tube-side spring seat 4 and the rod-side spring seat 5 with the outer tube 2 and the rod 3 inserted inside an inner periphery thereof, a stopper 8 provided on the outer tube 2 so as not to be movable in the axial direction, a seal case 12 serving as a cap body fixed to a rod-side end of the outer tube 2 with a flange 12a on an outer periphery of the seal case 12, and a tubular protector 7 sandwiched between the stopper 8 and the flange 12a and fixed to the outer periphery of the outer tube 2. Although not illustrated, for example, the shock absorber D is interposed between a sprung member serving as a vehicle body and an unsprung member such as a wheel in a motorcycle, a snowmobile, an all-terrain vehicle, or another saddle-type vehicle to generate a damping force during extension or contraction to suppress vibration of the sprung member.

Hereinafter, each part of the shock absorber D will be described. The shock absorber main body 1 includes an outer tube 2 and a rod 3 inserted into the outer tube 2 so as to be movable in the axial direction. For example, although not illustrated, the shock absorber main body 1 includes a piston connected to the rod 3 and inserted into the outer tube 2 so as to be movable in the axial direction to partition the inside of the outer tube 2 into an extension side chamber and a compression side chamber filled with hydraulic oil, and a damping passage allowing communication between the extension side chamber and the compression side chamber. The damping passage applies resistance to a flow of the hydraulic oil that moves between the extension side chamber and the compression side chamber during extension and contraction to generate a damping force that hinders extension and contraction.

As illustrated in FIG. 1, the outer tube 2 includes an annular groove 2a provided on the outer periphery near a lower end, which is the rod-side end, an inner peripheral screw portion 2b provided on an inner periphery at the rod-side end, and an outer peripheral screw portion 2c provided on the outer periphery and in an intermediate portion. The stopper 8, which is a C-shaped stopper ring, is placed in the annular groove 2a provided on the outer periphery of the outer tube 2. When the stopper 8 is fitted into the annular groove 2a, the diameter of the stopper 8 is reduced, and the stopper 8 is fixed to the annular groove 2a so as not to move in the axial direction.

A head cap 11 is placed at an upper end of the outer tube 2 in FIG. 1. The head cap 11 closes an open end, which is the upper end, of the outer tube 2, and includes an eye-type bracket 11a. Therefore, the shock absorber main body 1 can be connected to the sprung member in the saddle-type vehicle (not illustrated) using the eye-type bracket 11a of the head cap 11.

In the outer tube 2 configured as described above, a free piston (not illustrated) is accommodated in the outer tube 2 so as to be movable in the axial direction, and the inside of the outer tube 2 is partitioned by the free piston into a liquid chamber filled with hydraulic oil for the extension side chamber and the compression side chamber, and a gas chamber filled with gas. By moving in the outer tube 2, the free piston can expand one of the liquid chamber and the gas chamber while reducing the other in the outer tube 2. The gas chamber is filled with gas such that the pressure remains equal to or higher than the atmospheric pressure even when the free piston expands the gas chamber to its maximum extent, and the liquid chamber is pressurized to a pressure equal to or higher than the atmospheric pressure by the pressure in the gas chamber.

An upper end side of the rod 3 is inserted into the outer tube 2 through an inner periphery of the annular seal case 12 provided at the lower end of the outer tube 2 in FIG. 1, and a lower end side of the rod 3 protrudes to the outside of the outer tube 2.

The seal case 12 serving as a cap body holds a tubular bush 13 having an annular shape with its inner periphery being slidably in contact with an outer periphery of the rod 3, and a seal ring 14 that is slidably in contact with the outer periphery of the rod 3 to seal the outer periphery of the rod 3, and includes a flange 12a protruding radially outward on an outer periphery and having an outer diameter larger than an outer diameter of the outer tube 2. The seal case 12 includes a screw portion 12b on the outer periphery and on an upper side in FIG. 1, which is a side opposite to the rod, with respect to the flange 12a. A portion of the seal case 12 located on an upper side in FIG. 1 with respect to the flange 12a is inserted into the outer tube 2, and the screw portion 12b is screwed to the inner peripheral screw portion 2b to fix the seal case 12 immovably to the outer tube 2. An annular groove 12c in which the seal ring 16 is placed is provided between the flange 12a and the screw portion 12b on the outer periphery of the seal case 12, and the seal ring 16 adheres closely to an inner peripheral surface of the outer tube 2 to seal a space between the seal case 12 and the outer tube 2.

In the present embodiment, the flange 12a has a circular annular shape, but its shape is not limited to the circular annular shape as long as the flange 12a is capable of fixing the protector 7, which will be described below. The flange 12a may be formed of a protrusion protruding radially outward from one portion of the outer periphery of the seal case 12, or may be formed of a plurality of protrusions intermittently provided on the outer periphery of the seal case 12 along the circumferential direction.

During an extension or contraction operation in which the piston (not illustrated) moves in the vertical direction in FIG. 1 together with the rod 3 inside the outer tube 2, the shock absorber main body 1 configured as described above exerts a damping force that hinders its extension or contraction due to resistance given to a flow of hydraulic oil moving between the extension side chamber and the compression side chamber through a damping valve provided in the piston. In addition, during the extension or contraction operation of the shock absorber main body 1, the rod 3 moves into and out of the outer tube 2, and the volume of the rod 3 entering the outer tube 2 changes, but the change in volume is compensated for by the free piston moving up and down inside the outer tube 2 to expand and reduce the liquid chamber and the gas chamber.

Although the change in volume of the rod 3 in the outer tube 2 is compensated for by providing a gas chamber in the outer tube 2, the change in volume may also be compensated for by providing a tank having a gas chamber and a liquid chamber communicating with the compression side chamber outside the outer tube 2. In addition, the change in volume may also be compensated for by providing a cylinder inside the outer tube 2 and slidably inserting a piston into the cylinder to form an extension side chamber and a compression side chamber inside the cylinder, and providing, between the cylinder and the outer tube 2, a reservoir filled with gas and liquid and communicating with the compression side chamber. Furthermore, in a case where the tank or the reservoir is provided as described above, a damping valve or a variable damping valve capable of adjusting the damping force may be provided in a passage connecting the compression side chamber and the tank or the reservoir.

The outer tube-side spring seat 4 is attached to the outer peripheral screw portion 2c provided on the outer periphery of the outer tube 2. The outer tube-side spring seat 4 has an annular shape, and includes a nut portion 4a screwed to the outer peripheral screw portion 2c of the outer tube 2, and a flange-shaped spring seat 4b provided on an outer periphery of the nut portion 4a. Therefore, when the outer tube-side spring seat 4 is operated to rotate about the outer tube 2, the outer tube-side spring seat 4 can move in the axial direction with respect to the outer tube 2, thereby adjusting its position with respect to the outer tube 2 in the vertical direction in FIG. 1.

In addition, an eye-type bracket 15 enabling connection to an unsprung member in a saddle-type vehicle (not illustrated) is attached to a lower end of the rod 3. The rod-side spring seat 5 is attached to the rod 3 via the eye-type bracket 15, and disposed on the outer periphery at the lower end of the rod 3. Although not illustrated, a tubular cushion fitted onto the outer periphery of the rod 3 is provided above the rod-side spring seat 5 in FIG. 1, to come into contact with a lower end of the seal case 12 when the shock absorber D fully contracts, thereby mitigating an impact.

The rod-side spring seat 5 has an annular shape, and includes a recessed fitting portion 5a fitted to an upper end of the eye-type bracket 15 in FIG. 1, and a flange-shaped spring seat 5b provided on an outer periphery of the fitting portion 5a.

The coil spring 6 is interposed between the spring seat 4b of the outer tube-side spring seat 4 and the spring seat 5b of the rod-side spring seat 5. An inner periphery of an upper end of the coil spring 6 is fitted onto an outer periphery of the nut portion 4a of the outer tube-side spring seat 4, and an inner periphery of a lower end of the coil spring 6 is fitted onto an outer periphery of the fitting portion 5a of the rod-side spring seat 5. The movement of the upper end of the coil spring 6 in the radial direction with respect to the spring seat 4b is restricted, and the movement of the lower end of the coil spring 6 in the radial direction with respect to the spring seat 5b is restricted.

The coil spring 6 is interposed between the outer tube-side spring seat 4 and the rod-side spring seat 5 in a compressed state, and biases the shock absorber main body 1 in a direction to constantly extend the shock absorber main body 1.

The protector 7 includes a tubular protector main body 7a and an annular socket 7b extending in the axial direction from an opposite rod-side end of the protector main body 7a. When the protector 7 is fitted onto the outer periphery near the lower end in FIG. 1, which is the rod-side end, of the outer tube 2, the stopper 8, which is a stopper ring placed in the annular groove 2a, is inserted into the socket 7b. The socket 7b allows insertion of the stopper 8 placed in the annular groove 2a, but prevents the stopper 8 from expanding to a diameter that allows removal from the annular groove 2a in a state where the stopper 8 is accommodated in the socket 7b. That is, an inner diameter of the socket 7b is larger than an outer diameter of the stopper 8 placed in the annular groove 2a, and is smaller than an outer diameter of the stopper 8 when expanding to a diameter that allows removal from the annular groove 2a. When the stopper 8 expands and attempts to come out of the annular groove 2a, the socket 7b comes into contact with an outer periphery of the stopper 8 to restrict the expansion of the stopper 8, thereby preventing the stopper 8 from coming out of the annular groove 2a.

The protector 7 is fitted onto the outer periphery of the outer tube 2 and positioned such that an upper end in FIG. 1 of the protector main body 7a on the side opposite to the rod comes into contact with the stopper 8, and a lower end, which is a rod-side end, of the protector main body 7a is supported by the flange 12a of the seal case 12. Therefore, the protector 7 is sandwiched between the stopper 8 and the flange 12a and fixed in a fitted state onto the outer periphery of the outer tube 2.

Since the seal case 12 is screwed to the inner peripheral screw portion 2b of the outer tube 2, when the seal case 12 is screwed into the outer tube 2 after the flange 12a comes into contact with the protector 7, a load can be applied to the protector 7 in the axial direction while the protector 7 is sandwiched between the stopper 8 and the flange 12a, thereby firmly fixing the protector 7 to the outer tube 2.

Since the socket 7b that prevents the stopper 8 from coming out of the annular groove 2a when the stopper 8 is accommodated inside the socket 7b is provided in the protector 7, even if a load is applied to the protector 7 in the axial direction by screwing the seal case 12 as described above, the stopper 8 does not fall off from the annular groove 2a, thereby making it possible to apply, to the protector 7, a sufficient load necessary for fixing the protector 7 to the outer tube 2.

Note that the protector 7 is preferably formed of a synthetic resin having a self-lubricating property so as not to generate a large frictional force with the coil spring 6 when colliding with the coil spring 6, but may be formed of a metal or a material having low elasticity because the protector 7 is not deformed when placed on the outer tube 2.

When the shock absorber D configured as described above is in a contraction operation in which the rod 3 enters the outer tube 2 and the coil spring 6 is compressed as the outer tube-side spring seat 4 and the rod-side spring seat 5 approach each other, the coil spring 6 is buckled and bent around its center portion and the center portion of the coil spring 6 approaches the outer tube 2. Even when the coil spring 6 is buckled and the center portion approaches the outer periphery of the outer tube 2 in this manner, the protector 7 comes into contact with an inner peripheral side of a wire of the coil spring 6, thereby restricting an approach of the coil spring 6 to the outer tube 2, and preventing a contact between the coil spring 6 and the outer tube 2.

In addition, when the protector 7 is placed on the outer tube 2, the placement operation can be completed in a single step even if the stopper 8 is formed of a stopper ring, and the protector 7 can be sandwiched between the stopper 8 and the flange 12a to apply a sufficient load in the axial direction while the protector 7 prevents the stopper 8 from coming off, thereby easily and firmly fixing the protector 7 to the outer tube 2.

As described above, the shock absorber D according to the present embodiment includes a shock absorber main body 1 including an outer tube 2 and a rod 3 inserted into the outer tube 2 so as to be movable in an axial direction to generate a damping force during extension or contraction, an outer tube-side spring seat 4 attached to an outer periphery of the outer tube 2, a rod-side spring seat 5 attached to the rod 3, a coil spring 6 interposed between the outer tube-side spring seat 4 and the rod-side spring seat 5 with the outer tube 2 and the rod 3 inserted inside an inner periphery thereof, a stopper 8 provided on the outer tube 2 so as not to be movable in the axial direction, a seal case (cap body) 12 having an annular shape, allowing insertion of the rod 3 therethrough, including a flange 12a on an outer periphery thereof, and fixed to a rod-side end of the outer tube 2, and a tubular protector 7 sandwiched between the stopper 8 and the flange 12a and fixed to the outer periphery of the outer tube 2 while covering a part of the outer tube 2 to prevent interference between the coil spring 6 and the outer tube 2.

According to the shock absorber D configured as described above, even in a contraction operation in which the coil spring 6 is buckled and bent around its center portion, and the center portion of the coil spring 6 approaches the outer periphery of the outer tube 2, the protector 7 comes into contact with the inner peripheral side of the wire of the coil spring 6, thereby preventing interference between the coil spring 6 and the outer tube 2. In addition, according to the shock absorber D configured as described above, when fixing the protector 7 to the outer tube 2, the protector 7 can be easily assembled to the outer tube 2, because the protector 7 can be fixed to the outer tube 2, without requiring two stopper rings as in a conventional shock absorber, as the protector 7 is sandwiched between the stopper 8 and the flange 12a by providing the stopper 8 on the outer periphery of the outer tube 2, fitting the protector 7 onto the outer periphery of the outer tube 2, and then attaching the seal case (cap body) 12 to the outer tube 2.

In this manner, according to the shock absorber D of the present embodiment, assembly is facilitated when the protector 7 is fixed to the outer tube 2, and the protector 7 can be firmly fixed to the outer tube 2, thereby improving assembly workability and suppressing the protector 7 from falling off.

In addition, in the shock absorber D according to the present embodiment, the cap body is a seal case 12 that holds a seal ring 14 that seals the outer periphery of the rod 3. Therefore, by integrally providing a flange 12a in the seal case 12, which is essential for the configuration of the shock absorber D, a part and a structure used only for fixing the protector 7 to the outer tube 2 are unnecessary, thereby making it possible to minimize an increase in the number of parts used for fixing the protector 7 to reduce the manufacturing cost.

Further, in the shock absorber D according to the present embodiment, the stopper 8 is a stopper ring fitted into an annular groove 2a provided on the outer periphery of the outer tube 2, and the protector 7 includes a socket 7b fitted onto an outer periphery of the stopper ring to prevent the stopper 8 from coming out of the annular groove 2a. According to the shock absorber D configured as described above, even if a C-shaped stopper ring is used for the stopper 8, the socket 7b can prevent the stopper 8 from falling off, so that a load can be applied to the protector 7 in the axial direction while the protector 7 is sandwiched between the stopper 8 and the flange 12a, and the protector 7 can be firmly fixed to the outer tube 2.

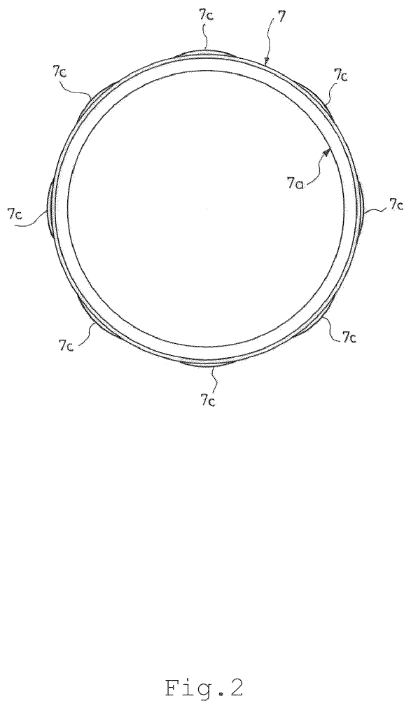

In addition, as illustrated in FIG. 2, in a case where the protector 7 includes a plurality of ribs 7c extending along the axial direction and provided side by side in the circumferential direction on an outer periphery of the protector main body 7a, even when the coil spring 6 is buckled during a contraction operation of the shock absorber D, the ribs 7c come into contact with the wire of the coil spring 6, thereby reducing a frictional force generated between the coil spring 6 and the ribs 7c and eliminating unnecessary resistance that may hinder the extension or contraction of the shock absorber D in an uncontrollable manner, and as a result, improving the ride comfort on the saddle-type vehicle. In addition, when the coil spring 6 contracts, the wire of the coil spring 6 rotates around the axis of the coil spring 6 to cause the protector 7 to rotate when coming into contact with the ribs 7c of the protector 7. Therefore, the protector 7 rotates little by little, and the contact locations of the wire of the coil spring 6 with respect to the ribs 7c change little by little, thereby making it possible to suppress uneven wear of the ribs 7c.

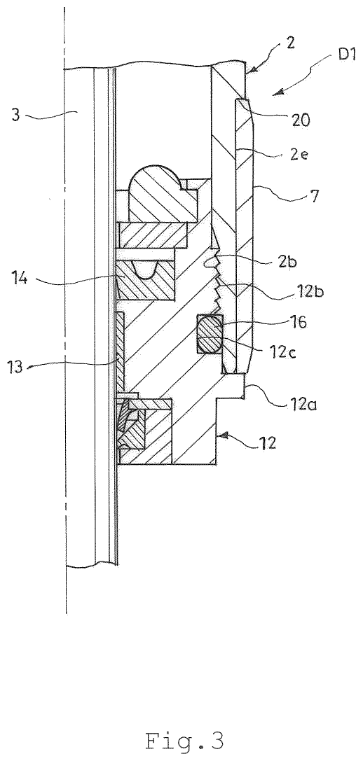

In the above description, the stopper 8 is a stopper ring placed in the annular groove 2a formed on the outer periphery of the outer tube 2. However, as in a shock absorber D1 according to a first modification illustrated in FIG. 3, a step portion 20 may be formed on the outer periphery of the outer tube 2 by reducing the outer diameter at the lower end in FIG. 3, which is the rod-side end, of the outer tube 2 to provide a small-diameter portion 2e, and the step portion 20 may be used as a stopper. In this case, the protector 7 is fitted onto the outer periphery of the outer tube 2 below the step portion 20 in FIG. 3, and is sandwiched between the step portion 20 and the flange 12a and fixed to the outer periphery of the outer tube 2. Since the stopper is the step portion 20 and does not require a stopper ring, the protector 7 does not need to include the socket 7b as illustrated in FIG. 3.

In the shock absorber D1 configured as described above, by forming the step portion 20 in the outer tube 2, a labor of placing a stopper, which is a part separate from the outer tube 2, on the outer tube 2 is eliminated, a troublesome task of placing a stopper ring is also unnecessary, and there is no need to worry about the stopper ring falling off. As a result, assembly is further facilitated when the protector 7 is fixed to the outer tube 2, and the protector 7 can be firmly fixed to the outer tube 2 while minimizing an increase in the number of parts used for fixing the protector 7 to reduce the manufacturing cost.

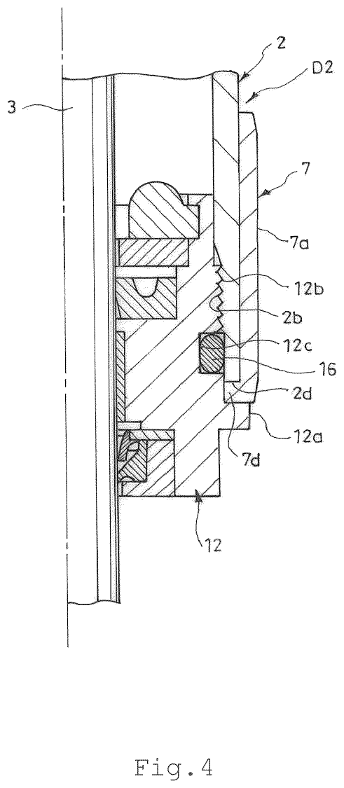

Further, as in a shock absorber D2 according to a second modification illustrated in FIG. 4, a rod-side end surface 2d, which is a lower end in FIG. 4 of the outer tube 2, may be used as a stopper. In this case, the protector 7 includes a tubular protector main body 7a and a protruding portion 7d provided on an inner periphery of the protector main body 7a, protruding radially inward, and sandwiched between the rod-side end surface 2d of the outer tube 2 as a stopper and the flange 12a.

The protruding portion 7d has an annular shape, and has an inner diameter smaller than the outer diameter of the outer tube 2 and larger than the inner diameter of the outer tube 2. Therefore, when the outer tube 2 is inserted into the protector 7, the protruding portion 7d comes into contact with the rod-side end surface 2d, and thereafter, when the seal case 12 is screwed to the outer tube 2, the protruding portion 7d is sandwiched between the rod-side end surface 2d and the flange 12a, and the protector 7 is fixed to the outer tube 2. In a case where the stopper is the rod-side end surface 2d on the rod side of the outer tube 2 in this manner, no stopper ring is required, and thus, the protector 7 does not need to include the socket 7b as illustrated in FIG. 4.

In the shock absorber D2 configured as described above, by using the rod-side end surface 2d of the outer tube 2 as a stopper and providing the protruding portion 7d on the inner periphery of the protector main body 7a of the protector 7, a labor of placing a stopper, which is a part separate from the outer tube 2, on the outer tube 2 is eliminated, a troublesome task of placing a stopper ring is also unnecessary, and there is no need to worry about the stopper ring falling off. As a result, assembly is further facilitated when the protector 7 is fixed to the outer tube 2, and the protector 7 can be firmly fixed to the outer tube 2 while minimizing an increase in the number of parts used for fixing the protector 7 to reduce the manufacturing cost. Note that the protruding portion 7d formed on the inner periphery of the protector main body 7a may not have an annular shape, and may be constituted by a plurality of protrusions intermittently provided along the circumferential direction. In addition, a step portion may be provided on the outer periphery of the outer tube 2, and the protector 7 may be fixed to the outer tube 2 by sandwiching the protruding portion 7d between the step portion and the flange 12a.

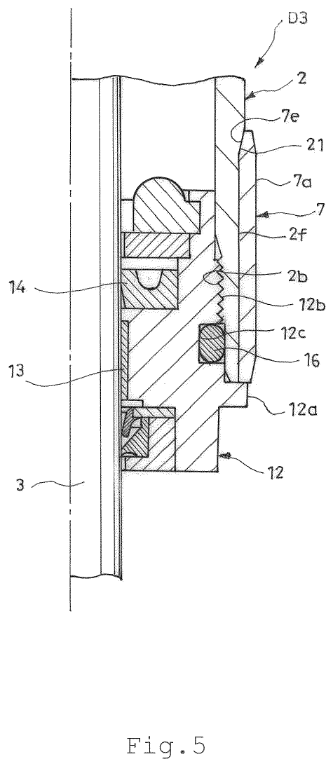

Further, as in a shock absorber D3 according to a third modification illustrated in FIG. 5, a tapered portion 21 may be provided in the vicinity of a rod-side end, which is a lower end in FIG. 5, on the outer periphery of the outer tube 2, and the tapered portion 21 may be used as a stopper. Specifically, the tapered portion 21 is formed by reducing the outer diameter at the lower end in FIG. 5, which is the rod-side end, of the outer tube 2, between a small-diameter portion 2f, which is a portion having a small outer diameter, and a portion having a large outer diameter, such that the outer diameter of the outer tube 2 gradually increases from the outer diameter of the small-diameter portion 2f having a small outer diameter to the outer diameter of the portion having a large outer diameter, that is, the outer diameter of the outer tube 2 increases toward the side opposite to the rod.

On the other hand, the protector 7 includes a tapered surface 7e fitted onto an outer periphery of the tapered portion 21 of the outer tube 2 on an inner periphery of the tubular protector main body 7a. The tapered surface 7e is inclined along the gradient of the outer peripheral surface of the tapered portion 21, and is fitted onto the outer periphery of the tapered portion 21 as the outer tube 2 is inserted into the protector 7. In this manner, by fitting the tapered surface 7e of the protector 7 to the tapered portion 21 of the outer tube 2, the protector 7 is restricted from moving upward in FIG. 5 with respect to the outer tube 2.

The protector 7 is fitted onto the outer periphery of the outer tube 2 and positioned such that the tapered surface 7e is fitted to the tapered portion 21, and the lower end, which is the rod-side end, is supported by the flange 12a of the seal case 12. Therefore, the protector 7 is sandwiched between the tapered portion 21 as a stopper and the flange 12a and fixed in a fitted state onto the outer periphery of the outer tube 2. Since the stopper is the tapered portion 21 and does not require a stopper ring, the protector 7 does not need to include the socket 7b as illustrated in FIG. 5.

In the shock absorber D3 configured as described above, by forming the tapered portion 21 in the outer tube 2 and providing the tapered surface 7e in the inner periphery of the protector 7, a labor of placing a stopper, which is a part separate from the outer tube 2, on the outer tube 2 is eliminated, a troublesome task of placing a stopper ring is also unnecessary, and there is no need to worry about the stopper ring falling off. As a result, assembly is further facilitated when the protector 7 is fixed to the outer tube 2, and the protector 7 can be firmly fixed to the outer tube 2 while minimizing an increase in the number of parts used for fixing the protector 7 to reduce the manufacturing cost.

In addition, since the tapered surface 7e provided in the protector 7 is fitted to the tapered portion 21 provided in the outer tube 2, the protector 7 can be fitted to the outer tube 2 without looseness, and by applying a load in the axial direction to the protector 7, a force is applied in the radial expansion direction to a portion of the protector 7 where the tapered surface 7e is provided, thereby obtaining a tensioning force by which the protector 7 tightens the outer tube 2, so that the protector 7 can be fixed to the outer tube 2 more firmly.

The position at which the tapered surface 7e is provided with respect to the protector main body 7a can be appropriately changed depending on the position at which the tapered portion 21 is provided with respect to the outer tube 2, and the entire inner peripheral surface of the protector main body 7a may be formed as the tapered surface 7e.

In any of the shock absorbers D, D1, D2, and D3 according to the present embodiment, the protector 7 is sandwiched between the stopper and the flange 12a by bringing the stopper into contact with the protector 7 and bringing the flange 12a into contact with the protector 7. However, the protector 7 may be sandwiched between the stopper and the flange 12a together with an intermediate member by sandwiching the intermediate member between the flange 12a and the protector 7 or between the stopper and the protector 7.

Further, the cap body is the seal case 12 fixed to the rod-side end of the outer tube 2 in any of the shock absorbers D, D1, D2, and D3 according to the present embodiment, but may be a part other than the seal case 12 as long as it is fixed to the rod-side end of the outer tube 2 while allowing insertion of the rod 3.

Although the preferred embodiment of the present invention has been described in detail above, modifications, variations, and changes can be made thereto without departing from the scope of the claims.

What is claimed is:

1. A shock absorber comprising:
a shock absorber main body including an outer tube and a rod inserted into the outer tube so as to be movable in an axial direction to generate a damping force during extension or contraction;
an outer tube-side spring seat attached to an outer periphery of the outer tube;
a rod-side spring seat attached to the rod;
a coil spring interposed between the outer tube-side spring seat and the rod-side spring seat with the outer tube and the rod inserted inside an inner periphery thereof;
a stopper provided on the outer tube so as not to be movable in the axial direction;
a cap body having an annular shape, allowing insertion of the rod, including a flange on an outer periphery thereof, and fixed to a rod-side end of the outer tube; and
a tubular protector sandwiched between the stopper and the flange and fixed to the outer periphery of the outer tube while covering a part of the outer tube to prevent interference between the coil spring and the outer tube.

2. The shock absorber according to claim 1, wherein
the cap body is a seal case that holds a seal ring that seals an outer periphery of the rod.

3. The shock absorber according to claim 1, wherein
the stopper is a stopper ring fitted into an annular groove provided on the outer periphery of the outer tube, and
the protector includes a socket fitted onto an outer periphery of the stopper ring to prevent the stopper from coming out of the annular groove.

4. The shock absorber according to claim 1, wherein
the stopper is a step portion formed at the rod-side end of the outer tube or a rod-side end surface.

5. The shock absorber according to claim 1, wherein
the stopper is formed by a tapered portion provided on the outer periphery of the outer tube and having an outer diameter that increases toward a side opposite to the rod, and
the protector has a tapered surface fitted to the tapered portion on an inner periphery thereof.

6. The shock absorber according to claim 4, wherein
the protector includes a tubular protector main body, and a protruding portion provided on an inner periphery of the protector main body, protruding radially inward, and sandwiched between the stopper and the flange.

7. The shock absorber according to claim 1, wherein
the protector includes
a tubular protector main body, and
a plurality of ribs extending along the axial direction and provided side by side in a circumferential direction on an outer periphery of the protector main body.
